(19) United States
(12) Patent Application Publication
(10) Pub. No.: US 2007/0055629 A1
(43) Pub. Date: Mar. 8, 2007

(54) Methods and apparatus for distributing content to support multiple customer service entities and content packagers

(75) Inventors: Gordon Kent Walker, Poway, CA (US); Joseph Barone, San Diego, CA (US); Bruce Collins, San Diego, CA (US); An Mei Chen, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/270,199

(22) Filed: Nov. 8, 2005

Related U.S. Application Data
(60) Provisional application No. 60/715,548, filed on Sep. 8, 2005.

(51) Int. Cl. G06Q 40/00

(52) U.S. Cl. 705/40

(57) ABSTRACT

System for distributing content to support multiple customer service entities and content packagers. A method is provided for distributing content. The method comprises receiving BCS parameters that identify one or more content packagers that are associated with one or more BCS providers. The method also includes receiving packager parameters that describe one or more packages associated with the one or more content packagers. The method also includes generating system information that comprises the BCS parameters and the packager parameters, and transmitting the system information.

### CLAIM OF PRIORITY UNDER 35 U.S.C. §119

The present Application for Patent claims priority to Provisional Application No. 60/715,548 entitled “METHODS AND SYSTEMS FOR PROVIDING MULTIPLE CUSTOMER SERVICE AND MULTIPLE RETAILERS ON A PERSONAL COMMUNICATIONS HANDHELD DEVICE” filed Sep. 8, 2005, and assigned to the assignee hereof and hereby expressly incorporated by reference herein.

### REFERENCE TO CO-PENDING APPLICATIONS FOR PATENT

The present Application for Patent is related to the following co-pending U.S. Patent Applications:

“APPARATUS AND METHODS OF OPEN AND CLOSED PACKAGE SUBSCRIPTION”, having Attorney Docket No. 051242, filed concurrently herewith, assigned to the assignee hereof, and expressly incorporated by reference herein, “METHOD AND APPARATUS FOR DELIVERING CONTENT BASED ON RECEIVERS CHARACTERISTICS”, having Attorney Docket No. 051256, filed concurrently herewith, assigned to the assignee hereof, and expressly incorporated by reference herein, “APPARATUS AND METHODS FOR PROVIDING AND PRESENTING CUSTOMIZED CHANNEL INFORMATION”, having Attorney Docket No. 051260, filed concurrently herewith, assigned to the assignee hereof, and expressly incorporated by reference herein, “APPARATUS AND METHODS FOR DELIVERING AND PRESENTING AUXILIARY SERVICES FOR CUSTOMIZING A CHANNEL”, having Attorney Docket No. 051263, filed concurrently herewith, assigned to the assignee hereof, and expressly incorporated by reference herein, “METHODS AND APPARATUS FOR DELIVERING REGIONAL PARAMETERS”, having Attorney Docket No. 060109, filed concurrently herewith, assigned to the assignee hereof, and expressly incorporated by reference herein, “METHODS AND APPARATUS FOR FRAGMENTING SYSTEM INFORMATION MESSAGES IN WIRELESS NETWORKS”, having Attorney Docket No. 060136, filed concurrently herewith, assigned to the assignee hereof, and expressly incorporated by reference herein, “FLEXIBLE SYSTEM FOR DISTRIBUTING CONTENT TO A DEVICE”, having Attorney Docket No. 060137, filed concurrently herewith, assigned to the assignee hereof, and expressly incorporated by reference herein, “SYSTEM FOR DISTRIBUTING PACKAGES AND CHANNELS TO A DEVICE” having Attorney Docket No. 060138, filed concurrently herewith, assigned to the assignee hereof, and expressly incorporated by reference herein; and “METHODS AND APPARATUS FOR PROVIDING SYSTEM INFORMATION TO A WIRELESS DEVICE”, having Attorney Docket No. 060153P1, filed concurrently herewith, assigned to the assignee hereof, and expressly incorporated by reference herein.

### BACKGROUND

1. Field

The present Application for Patent relates generally to content distribution systems, and more particularly, to a system for distributing content on a data network to support multiple content packagers and customer service entities.

2. Background

In current content delivery/media distribution systems, a billing and customer service (BCS) provider make services available over a proprietary network, so that devices operating on that network will have the ability to receive those services. For example, a single BCS provider is able to offer services available from one or more content packagers. For a typical portable device, the entire relationship between the customer and the network is managed by the BCS provider exclusively. This results in the device (customer) buying all services through the primary network's BCS provider.

Unfortunately, this situation may be acceptable, when the voice, data, and media networks have a single ownership; however, as devices gain access to multiple networks, there is an increasing need to support multiple BCS providers so that a device may receive a wide variety of service offerings.

Therefore, what is needed is a system to distribute content that supports multiple BCS providers and multiple content packagers associated with those BCS providers.

### SUMMARY

In one or more embodiments, is distribution system is provided that operates to support multiple BCS providers and multiple content packagers to distribute content.

In one embodiment, a method is provided for distributing content. The method comprises receiving BCS parameters that identify one or more content packagers that are associated with one or more BCS providers. The method also comprises receiving packager parameters that describe one or more packages associated with the one or more content packagers. The method also comprises generating system information that comprises the BCS parameters and the packager parameters, and transmitting the system information.

In one embodiment, an apparatus is provided for distributing content. The apparatus comprises receiver logic configured to receive BCS parameters that identify one or more content packagers that are associated with one or more BCS providers, and packager parameters that describe one or more packages associated with the one or more content packagers. The apparatus also comprises system information logic configured to generate system information that comprises the BCS parameters and the packager parameters, and transmitter logic configured to transmit the system information.

In one embodiment, an apparatus is provided for distributing content. The apparatus comprises means for receiving BCS parameters that identify one or more content packagers that are associated with one or more BCS providers, and means for receiving packager parameters that describe one or more packages associated with the one or more content packagers. The apparatus also comprises means for generating system information that comprises the BCS parameters and the packager parameters, and means for transmitting the system information.

In one embodiment, a computer-readable media is provided that comprises instructions, which when executed by at least one processor, operate to distribute content. The computer-readable media comprises instructions for receiving BCS parameters that identify one or more content packagers that are associated with one or more BCS providers, and instructions for receiving packager parameters that describe one or more packages associated with the one or more content packagers. The computer-readable media also comprises instructions for generating system information that comprises the BCS parameters and the packager parameters, and instructions for transmitting the system information.

In one embodiment, at least one processor is provided that is configured to perform a method for distributing content. The method comprises receiving BCS parameters that identify one or more content packagers that are associated with one or more BCS providers, and receiving packager parameters that describe one or more packages associated with the one or more content packagers. The method also comprises generating system information that comprises the BCS parameters and the packager parameters, and transmitting the system information.

In one embodiment, a method is provided for distributing content. The method comprises receiving system information messages, and determining a BCS provider identifier. The method also comprises parsing the system information messages based on the BCS provider identifier to determine parsed system information parameters, and rendering a selected portion of the parsed system information parameters.

In one embodiment, an apparatus is provided for distributing content. The apparatus comprises receiving logic configured to receive system information messages, and parsing logic configured to determine a BCS provider identifier, and parse the system information messages based on the BCS provider identifier to determine parsed system information parameters. The apparatus also comprises rendering logic configured to render a selected portion of the parsed system information parameters.

In one embodiment, a computer-readable media is provided that comprises instructions, which when executed by at least one processor, operate to distribute content. The computer-readable media comprises instructions for receiving system information messages, and instructions for determining a BCS provider identifier. The computer-readable media also comprises instructions for parsing the system information messages based on the BCS provider identifier to determine parsed system information parameters, and instructions for rendering a selected portion of the parsed system information parameters.

Other aspects of the embodiments will become apparent after review of the hereinafter set forth Brief Description of the Drawings, Description, and the Claims

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a network that comprises an embodiment of a distribution system;

FIG. 2 shows a detailed diagram of an embodiment of a distribution server suitable for use in embodiments of a distribution system;

FIG. 3 shows an embodiment of a method for operating a server in embodiments of a distribution system;

FIG. 4 shows a detailed diagram of an embodiment of a device suitable for use in embodiments of a distribution system;

FIG. 5 shows an embodiment of a method for operating a device in embodiments of a distribution system;

FIG. 6 shows an embodiment of a system information structure for use in embodiments of a distribution system;

FIG. 7 shows an embodiment of a Marketplace Common message schema for use in embodiments of a distribution system;

FIG. 8 shows an embodiment of a Marketplace Content Packager message schema for use in embodiments of a distribution system;

FIG. 9 shows a detailed diagram of an embodiment of a package record schema for use in embodiments of a distribution system;

FIG. 10 shows an embodiment of a service definition message schema for use in embodiments of a distribution system; and

FIG. 11 shows an embodiment of a service record schema for use in embodiments of a distribution system.

### DESCRIPTION

The following detailed description describes embodiments of a distribution system that supports multiple BCS providers and multiple content packagers. The system is especially well suited for distributing services/content to portable devices having limited resources, but may be used with any type of device. The system may also be used in any type of network environment, including but not limited to, communication networks, public networks, such as the Internet, private networks, such as virtual private networks (VPN), local area networks, wide area networks, long haul networks, or any other type of data or communication network.

The following definitions are used herein to describe embodiments of the distribution system.
BCS Provider A billing and customer service (BCS) provider is an entity that accepts and maintains user subscriptions to available packages. In one embodiment, each device is associated with a single BCS provider. In another embodiment, each device may be associated with one or more BCS providers.
Content Packager A content packager is an entity that defines and maintains packages.
Content Provider A content provider is an entity that supplies the content of a service. The content provider also supplies descriptions of the content.
Package A package is a collection of one or more tiers that are offered on a subscription basis.
Tier A tier is a collection of one or more services.
Service A service comprises a sequence of presentations offered under a single label and delivered using a defined set of flows. A service represents the smallest element that may be subscribed to in the distribution system.

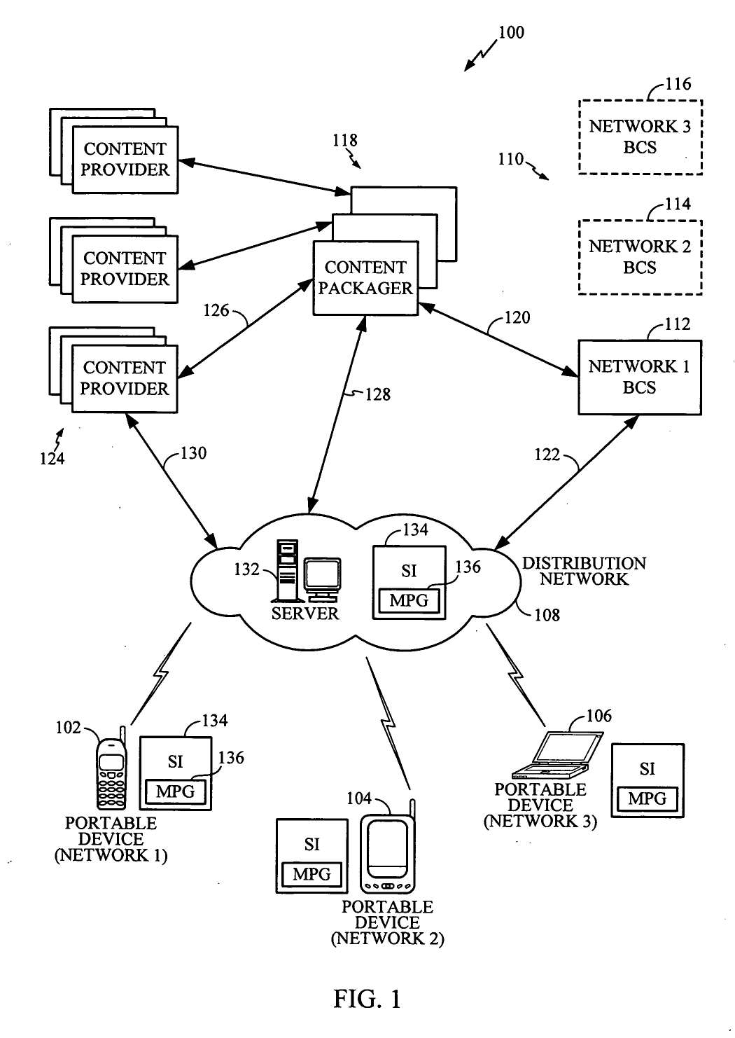

FIG. 1 shows a network 100 that comprises an embodiment of a distribution system. The network 100 comprises portable devices (102, 104 and 106), BCS providers 110, content packagers 118, and content providers 120 all coupled to a distribution network 108.

The devices (102, 104 and 106) are portable devices that communication with the distribution network 108 to allow a device users to access the distribution network 108 to subscribe to receive available packages.

The BCS providers 110 accept and maintain user subscriptions that are received from devices through the distribution network 108. Each of the devices (102, 104 and 106) is associated with a single BCS provider. For example, the device 102 is associated with BCS 112, device 104 is associated with BCS 114, and device 106 is associated with BCS 116. For clarity, only the operation of the BCS provider 112 is described in detail in the following sections; however, the BCS providers 114 and 116 operate in a similar fashion.

The BCS provider 112 establishes communications 120 with one or more content packagers 118. In these communications 120, information is exchanged that identifies one or more packages that the content packagers 118 will offer to devices associated with the BCS provider 112. The BCS provider 112 then transmits BCS parameters 122 to the distribution network 108 that identify the packages to be associated with the BCS provider 112.

The content packagers 118 define and maintain packages. The content packagers 118 establish communications 126 with one or more content providers 124. In these communications 126, information is exchanged that identifies one or more packages that the content providers 124 will offer for subscription through content packagers 118. The content packagers 118 then transmits packager parameters 128 to the distribution network 108 that identify the packages offered by the content packagers 118. It should be note that a particular content packager may be associated with more than one BCS provider.

The content providers 124 supply the content of the services to the distribution network 108 in programming parameters 130. The programming parameters 130 also comprise descriptions of the content that allows the distribution network 108 to maintain a media presentation guide (MPG) which provides a description of the packages and associated services available through the distribution network 108 at any given time. Alternatively a description of the packages and associated services available through the distribution network 108 may be provided to the device user through any other type of user interface. It should be note that a particular content provider may be associated with more than one content packager.

The distribution network 108 is responsible for the delivery of the services to the devices (102, 104 and 106). It is also responsible for the creation and delivery of accompanying system information (SI) parameters. In one embodiment, the communications between the distribution network 108 and the devices (102, 104 and 106) are organized into a set of flows, e.g. to carry different media components of a real time service, or IP streams addressed to different IP ports in an IP Datacast service. All flows which are to be made available in a particular local or wide area are grouped into a corresponding multiplex.

The distribution network 108 comprises any combination of wired and wireless network technologies. For example, the distribution network 108 may be a wireless multicast/broadcast network. In one embodiment, the distribution network 108 comprises server 132 that operates to receive the BCS parameters 122 from one more of the BCS providers 110. The server 132 also receives the packager parameters 128 from the content packagers 118, and programming parameters 130 from the content providers 124. The server 132 processes the received parameters to generate the system information (SI) parameters 134, which comprises the media presentation guide (MPG) 136.

The SI parameters 134 comprise a set of information that enables a device to locate and/or subscribe to available packages and services. The SI also comprises package and service descriptions and MPG 136. The MPG 136 comprises a schedule of available titles that is delivered to a device as a sequence of MPG blocks.

During operation of an embodiment of the distribution system, the distribution network 108 activates the devices (102, 104 and 106) and transmits the SI 134, which the devices (102, 104 and 106) are able to receive. The devices (102, 104 and 106) then operate to process the SI 134 and associated MPG 136 to render information to the device users to see available packages and/or services. The device users are then able to subscribe to receive one or more packages. For example, the user of the device 102 selects a package for subscription from information rendered from the SI 134. The device 102 then transmits a subscription request to the distribution network 108 to subscribe to the selected package. The subscription request is then processed by the distribution network and forwarded to the BCS provider associated with the requesting device. The BCS provider then operates to subscribe the device to receive the requested package.

In one or more embodiments, the distribution server 132 operates in an embodiment of the distribution system by performing one or more of the following functions.
1. Obtain BCS, packager, and programming parameters associated with selected BCS providers, content packagers and content providers.
2. Generate SI with associated MPG parameters.
3. Transmit the SI to activated devices.
5. Receive one or more subscription requests from the devices.

Thus, embodiments of the distribution system operate to support multiple BCS providers and multiple content packagers to allow device to subscribe to receive available packages. It should be noted that the network 100 illustrates just one configuration, and that other configurations or arrangements are possible within the scope of the described embodiments.

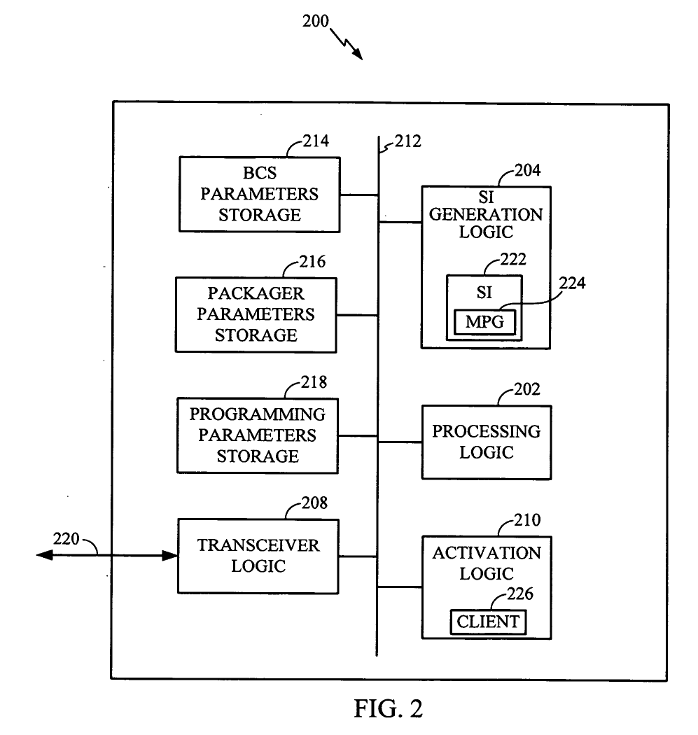

FIG. 2 shows a detailed diagram of an embodiment of a distribution server 200 suitable for use in embodiments of a distribution system. For example, the distribution server 200 may be used as the distribution server 132 in FIG. 1. The distribution server 200 comprises processing logic 202, SI generation logic 204, transceiver logic 208, and activation logic 210 all coupled to an internal data bus 212. The server 200 also comprises BCS parameter storage 214, packager parameter storage 216, and programming parameter storage 218, which are all also coupled to the data bus 212.

In one or more embodiments, the processing logic 202 comprises a CPU, processor, gate array, hardware logic, memory elements, virtual machine, software, and/or any combination of hardware and software. Thus, the processing logic 202 generally comprises logic to execute machine-readable instructions and to control one or more other functional elements of the server 200 via the internal data bus 212.

The transceiver logic 208 comprises hardware and/or software that operate to allow the server 200 to transmit and receive data and/or other information with remote devices or systems via communication channel 220. For example, in one embodiment, the communication channel 220 comprises any suitable type of communication link to allow the server 200 to communicate with one or more data networks and/or devices coupled to those data networks.

The storage logic (214, 216, and 218) comprises any suitable type of storage devices or elements that allow the server 200 to store information parameters. For example, in one embodiment the storage logic (214, 216, and 218) comprises any type of RAM, Flash memory, hard disk, or any other type of storage device.

In one embodiment, the processing logic 202 operates to communicate with one or more BCS providers through the transceiver logic 208 and channel 220. The BCS providers provide BCS parameters that are received by the processing logic 202 and stored in the BCS parameter storage 214. The processing logic 202 also operates to communicate with one or more content packagers through the transceiver logic 208 and channel 220. The content packagers provide packager parameters that are receive by the processing logic 202 and stored in the packager parameter storage 216. The processing logic 202 also operates to communicate with one or more content providers. The content providers provide programming parameters that are received by the processing logic 202 and stored in the programming parameters storage 218. A more detailed description of the BCS, packager, and programming parameters is provided in another section of the document.

In one or more embodiments, the SI generation logic 204 comprises a CPU, processor, gate array, hardware logic, memory elements, virtual machine, software, and/or any combination of hardware and software. The SI generation logic 204 operates to retrieve parameters from the storage (214, 216, and 218) to generate SI parameters 222. For example, the SI logic 204 retrieves BCS parameters from the storage 214 that are associated with one or more BCS providers. The SI logic 204 also operates to retrieve packager parameters from the storage 216 and programming parameters from the storage 218. Once the parameters are retrieved, the SI generation logic 204 operates to generate SI parameters 222. A more detailed description and format of the SI parameters 222 is provided in another section of this document.

The SI generation logic 204 also operates to retrieve parameters from the programming parameters storage 218 to generate a MPG 224 that is associated with the SI 222. The MPG 224 provides information and descriptions about available packages, which may be rendered on a device to allow a device user to subscribe to one or more packages.

The activation logic 210 comprises a CPU, processor, gate array, hardware logic, memory elements, virtual machine, software, and/or any combination of hardware and software. The activation logic 210 operates to activate a device to allow the device to subscribe to available packages. The activation process need only occur once for each device that desires to subscribe to packages. For example, in one embodiment, the activation logic 210 comprises a client application 226 that is downloaded to the device during the activation process. For example, the client 226 is downloaded to the device using the transceiver logic 208. Once a device is activated by the activation logic 210, the client 226 runs on the device and operates to receive the SI 222 and display information about available packages and other related information to the device user. Thus, the activation logic 210 operates to allow the server 200 to identify and authenticate a device, thereby allowing the device to subscribe to one or more available packages.

In an embodiment, the server 200 operates to multicast/broadcast the SI parameters 222 to activated devices. The clients executing on the devices operates to receive the SI parameters 222 and render information from the SI 222 and MPG 224 so that the device users may see and subscribe to available packages.

In one embodiment, the server 200 comprises program instructions stored on a computer-readable media, which when executed a processor, for instance, the processing logic 202, provides the functions of the distribution system described herein. For example, instructions may be loaded into the server 200 from a computer-readable media, such as a floppy disk, CDROM, memory card, FLASH memory device, RAM, ROM, or any other type of memory device or computer-readable media that interfaces to the server 200. In another embodiment, the instructions may be downloaded into the server 200 from an external device or network resource that interfaces to the server 200 through the transceiver logic 208. The instructions, when executed by the processing logic 202, provide one or more embodiments of a distribution system as described herein.

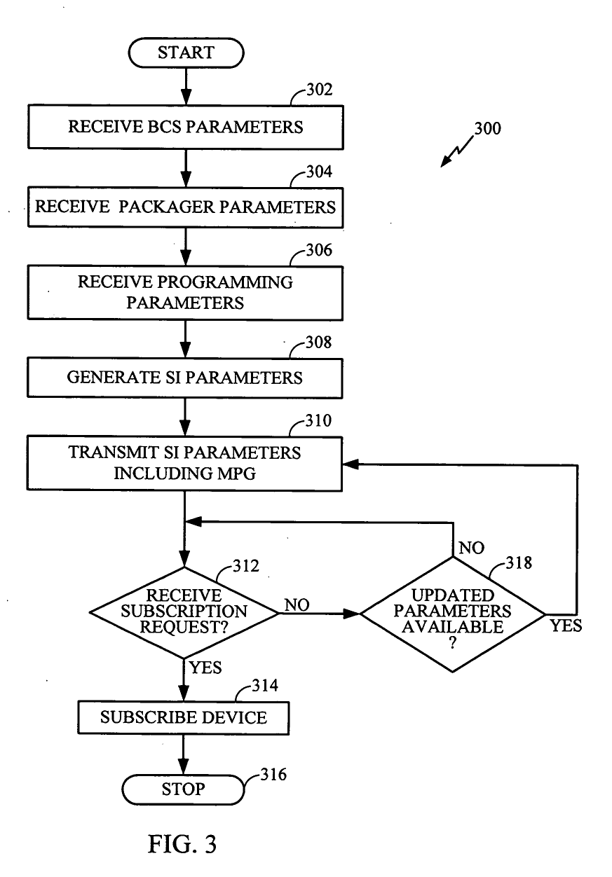

FIG. 3 shows an embodiment of a method 300 for operating a server in an embodiment of a distribution system. For clarity, the method 300 will be described with reference to the server 200 shown in FIG. 2. In one or more embodiments, the processing logic 202 executes program instructions and controls the operation of the server 200 to perform the functions described below. The method 300 assumes that the server 200 has activated one or more devices so that those activated devices may subscribe to available packages.

At block 302, BCS parameters are received. For example, in one embodiment, one or more BCS providers transmit BCS parameters to the server 200. The BCS parameters are received by the transceiver logic 208 and stored in the BCS parameter storage 214. The BCS parameters identify packages that will be offered for subscription to devices associated with one or more BCS providers.

At block 304, packager parameters are received. For example, in one embodiment, one or more content packagers transmit packager parameters to the server 200. The packager parameters are received by the transceiver logic 208 and stored in the content packager parameter storage 216. The packager parameters identify content providers and services associated with packages provided by each content packager.

At block 306, programming parameters are received. For example, in one embodiment, one or more content providers transmit programming parameters to the server 200. The programming parameters are received by the transceiver logic 208 and stored in the programming parameter storage 218. The programming parameters identify and describe content, scheduling and other information related to the distribution of service over the distribution network.

At block 308, SI parameters are generated. For example, in one embodiment, the SI generation logic 204 operates to retrieve parameters from the BCS storage 214, packager storage 216 and programming storage 218 to generate the SI parameters 222 and associated MPG 224.

At block 310, SI parameters including the MPG are transmitted over a distribution network and received by activated devices. For example, in one embodiment, the processing logic 202 operates to transmit the SI parameters 224 to the distribution network through the transceiver logic 208. The client application executing at the activated devices processes the received SI 222 and associated MPG 224 parameters and renders a program guide that allows the device user to select one or more package for subscription. During the subscription process, the device generates a subscription message that is transmitted to the server 200 and received by the transceiver logic 208.

At block 312, a test is performed to determine if a subscription request has been received. For example, the processing logic 202 operates to determine if subscription requests from one or more activated devices have been received by the transceiver logic 208. If no subscription requests have been received, the method proceeds to block 318. If a subscription request has been received, the method proceeds to block 314.

At block 314, the device is subscribed to receive the requested package. In one embodiment, the processing logic 202 communicates with the BCS provider associated with the requesting device to subscribe the device to receive the requested package. The method then stops at block 316.

At block 318, a test is performed to determine if any of the SI parameters have been updated. For example, the processing logic 202 operates to determine if updated BCS 214, packager 216 or programming 218 parameters have been received so that the SI generation logic 204 has generated an updated SI 222. If there have been no parameter updates, the method proceeds to block 312 to determine if any subscription requests have been received. If there have been updates, the method proceeds to block 310 where the updated SI 222 parameters are transmitted to activated devices.

Thus, the method 300 can be used to operate a server in an embodiment of a distribution system. It should be noted that the method 300 illustrates just one implementation and that changes, additions, or rearrangements of the described functions may be made without deviating from the scope of the described embodiments.

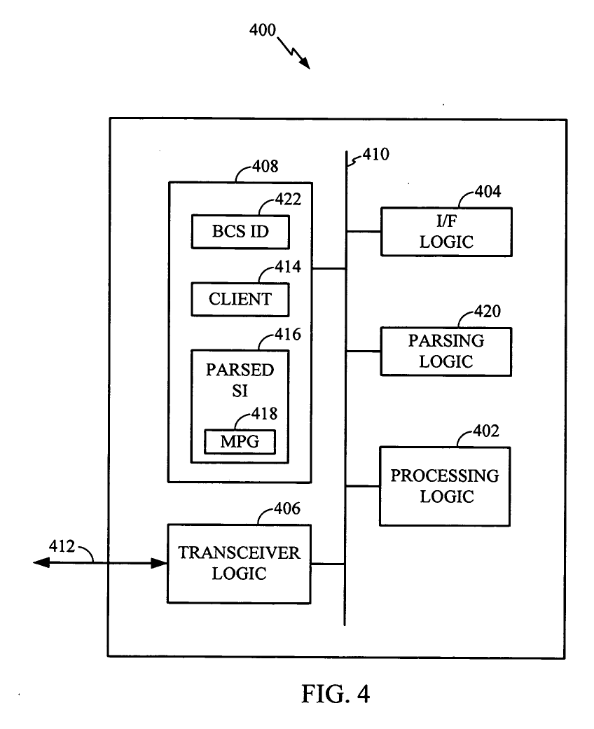

FIG. 4 shows a detailed diagram of an embodiment of a device 400 suitable for use in embodiments of a distribution system. The device 400 comprises processing logic 402, device resources and interface logic 404, transceiver logic 406, a memory 408, and parsing logic 420 all coupled to a data bus 410.

In one or more embodiments, the processing logic 402 comprises a CPU, processor, gate array, hardware logic, memory elements, virtual machine, software, and/or any combination of hardware and software. Thus, the processing logic 402 generally comprises logic to execute machine-readable instructions and to control one or more other functional elements of the device 400 via the internal data bus 410.

The device resources and interface logic 404 comprise hardware and/or software that allow the device 400 to communicate with internal and external systems. For example, internal systems may include mass storage systems, memory, display driver, modem, or other internal device resources. The external systems may include user interface devices, printers, disk drives, or other local devices or systems. Thus, the device resources and interface logic 404 allows the device to render information on a device display and to receive user inputs through a user input device, such as a mouse, keypad, touch screen, or any other type of user input device.

The transceiver logic 406 comprises hardware and/or software that operate to allow the device 400 to transmit and receive data and/or other information with external devices or systems via communication channel 412. For example the communication channel 412 may comprise a network communication link, a wireless communication link or any other type of communication link.

The memory 408 comprises any suitable type of storage device or element that allows the device 400 to store information parameters. For example, in one embodiment the memory 408 comprises any type of RAM, Flash memory, hard disk, or any other type of storage device.

In one or more embodiments, the parsing logic 420 comprises a CPU, processor, gate array, hardware logic, memory elements, virtual machine, software, and/or any combination of hardware and software. The parsing logic 420 generally comprises logic to parse system information messages that are received by the transceiver logic 406.

During operation of one or more embodiments, the device 400 is activated with a distribution server thereby allowing the device 400 to subscribe to available packages. As part of the activation process, the device provides a BCS identifier 422 to the distribution server using the transceiver logic 406. For example, the BCS identifier 422 may be stored in the memory 408 during device manufacture. The BCS identifier 422 identifies a BCS provider that is associated with the device 400. As part of the activation process, the device 400 receives a client application 414. The client application 414 is stored in the memory 408 and executes on the device 400 to provide a user interface that allows a device user to view information about available packages.

The distribution network transmits SI messages that are received by the transceiver logic 406. The parsing logic 420 operates to parse the received SI message to produced parsed SI parameters 416 that include MPG 418, which are stored in the memory 408. For example, the parsing logic 420 obtains the BCS identifier 422 from the memory and uses this identifier to parse received system information messages transmitted from a distribution server. The parsed SI 416 comprises information from the received SI messages that are related to the BCS provider associated with the device 400. Thus, the parsed SI 416 can be rendered on the device 400 to show the device user only those packages available to the device 400. If the device 400 is associated with more than one BCS provider, a similar process is performed to allow the device 400 to render information about available packages from all BCS providers associated with the device. For example, multiple BCS identifiers are stored at the device 400 and used to parse received SI messages.

The client 414 provides a user interface (UI) that renders the parsed SI 416 and associated MPG 418 on the device 400 to allow the device user to view the available packages. The client 414 also allows the device user to select one or more packages for subscription. The selected packages are identified in a subscription request that is part of a device-to-server protocol, which is implemented by the client 414. The client 414 then transmits the subscription request to the distribution server through the transceiver logic 406 and channel 412.

In one embodiment, the device 400 performs one or more of the following functions in one or more embodiments of a distribution system. It should be noted that the following functions may be changed, rearranged, modified, added to, or otherwise adjusted within the scope of the embodiments.
1. The device receives and installs a client application.
2. The device is activated with a distribution system.
3. The device receives SI messages.
4. The device parses the SI messages to produced parsed SI parameters and associated MPG
4. The MPG is rendered on the device and displays the available packages to the device user.
5. After the user selects one or more packages for subscription, the client assembles a subscription request that is transmitted to the distribution system.
6. After the subscription request has been process by the distribution system, the device receives the services for which the user has subscribed.

In one embodiment, the distribution system comprises program instructions stored on a computer-readable media, which when executed by a processor, such as the processing logic 402, provides the functions of the device 400 described herein. For example, instructions may be loaded into the device 400 from a computer-readable media, such as a floppy disk, CDROM, memory card, FLASH memory device, RAM, ROM, or any other type of memory device or computer-readable media that interfaces to the device 400 via the device I/F logic 404. In another embodiment, the instructions may be downloaded into the device 400 from a network resource that interfaces to the device 400 via the transceiver logic 406. The instructions, when executed by the processing logic 402, provide one or more embodiments of a distribution system as described herein.

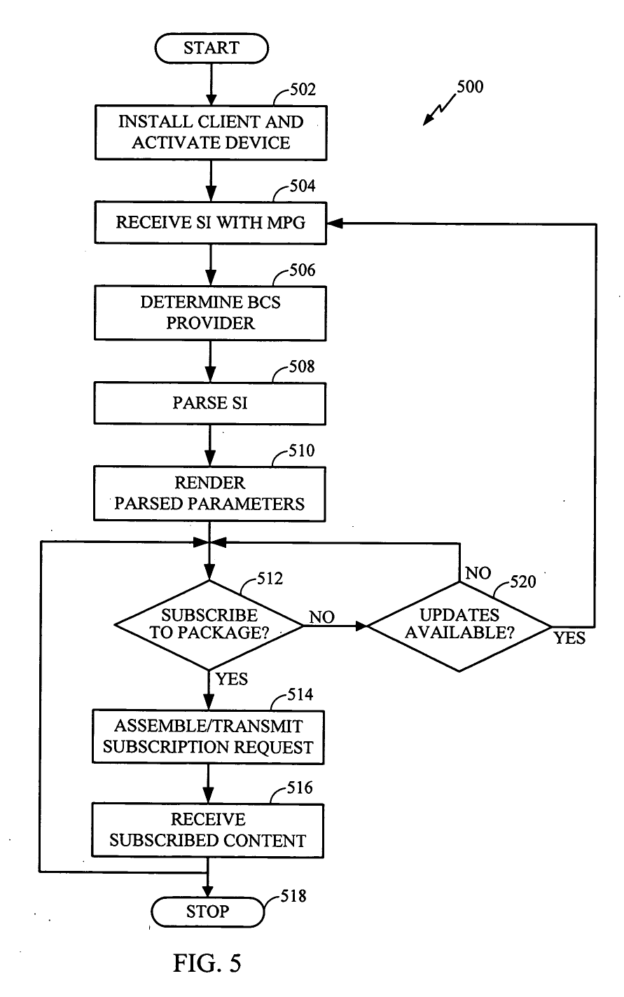

FIG. 5 shows an embodiment of a method 500 for operating a device in embodiments of a distribution system. For clarity, the method 500 will be described with reference to the device 400 shown in FIG. 4. For example, the device 400 is suitable for use as any of the devices (102, 104, 106) shown in FIG. 1. In one or more embodiments, the processing logic 402 executes program instructions to control the device 400 to perform the functions described below.

At block 502, the device is activated with a distribution server. For example, in one embodiment, the processing logic 402 communicates with a distribution server through the transceiver logic 406 to identify the device and provide any other activation information that may be required. As part of the activation process, a client 414 is installed on the device. In one embodiment, the client 414 is installed in the memory 408 and executes to establish communications with the distribution server using a selected communication protocol.

At block 504, the latest SI messages transmitted from the distribution server are received at the device. For example, the transceiver logic 406 receives the SI messages using the communication channel 412.

At block 506, a BCS provider identifier is determined. For example, the parsing logic 420 retrieves the BCS identifier 422 from the memory 408.

At block 508, the received SI messages are parsed to determine parsed SI parameters. For example, the parsing logic 420 operates to parse the received SI messages based on the BCS identifier 422. For example, the BCS identifier 422 is compared to BCS provider information included in the system information messages. If any of the system information messages pertain to a BCS provider that matches the BCS identifier 422, then those messages are parsed by the parsing logic 420 to obtain system information parameters that apply to the device 400. Thus, messages that contain information relative to the BCS identifier 422 are parsed by the parsing logic 420 to produce parsed SI parameters 416 with associated MPG 418 that are stored in the memory 408.

At block 510, the client installed on the device operates to display or render information from the parsed SI parameters to the device user. For example, the parsed SI parameters 416 comprise a MPG 418 that provides information to the device user about the packages available for subscription. For example, the information includes scheduling, pricing, availability, and any other relevant information. In one embodiment, the client 406 operates to display information from the MPG 418 using the I/F logic 404.

At block 512, a test is performed to determine if the user wishes to subscribe to one or more available packages. For example the user may select one or more packages from the displayed program guide and request to subscribe to those packages. If the user selects any package for subscription, the method proceeds to block 514. If the user does not select any packages for subscription, the method proceeds to block 520.

At block 520, a test is performed to determine if there are updated parsed SI parameters. For example, in one embodiment, the processing logic 402 listens to transmission from the distribution server to determine if the version of the currently broadcast SI parameters is different from the parameters that are stored in the device memory 408. If new parameters are available the method proceeds to block 504 to obtain the new information. If no new parameters are available, the method proceeds to block 512 to determine if the device user wishes to subscribe to any available package.

At block 514, a subscription request is assembled and transmitted to the distribution network. The subscription request allows the device user to subscribe to the selected packages. For example, the subscription request is assembled in a format that allows one or more packages to be identified for subscription. In one embodiment, the client 414 operates to assemble the subscription request. The subscription request is then transmitted to the distribution server using the transceiver logic 406.

At block 516, services associated with the requested package are received at the device. For example, after the distribution server has processed the subscription request, the services associated with the subscribed package are delivered to the device. For example, in one embodiment, the services are delivered to the device from a content provider through the distribution network and received by the transceiver logic 406. The method then stops at block 518.

Thus, the method 500 operates to allow a device to subscribe to one or more packages provided in a distribution system. It should be noted that the method 500 illustrates just one implementation and that changes, additions, or rearrangements of the functional elements may be made without deviating from the scope of the described embodiments.

System Information

The following is a detailed description of SI parameters generated in embodiments of a distribution system. The SI parameters are formatted into structures that allow the delivery of customer care and billing and possibly other services to be separated from the retailing of content or other services. These structures allow the BCS providers to control which content packagers provide services to its associated devices, but the BCS providers may not be in control of either the content or the pricing. Provisions are made to allow the BCS providers to sell content and additional services in addition to the initial service contract. The structure of the service offerings from each of the content packagers is such that the offerings can be displayed on a single user interface with a consistent display order. This defined ordering is for the subscription packages that are available across multiple content packagers, which may be associated with multiple and/or different BCS providers.

System Information structures allow the BCS providers control over which content packagers are available to its associated devices. Cost and terms for each content packager is independent of the BCS provider. The content and subscription options described by each content packager is independently defined, but can be merged into a single user interface. In one embodiment, this is accomplished through records in the SI as described in the following SI specification. It should be noted that the modifications, changes, deletions, additions, combinations or other minor variations to the described SI are within the scope of the embodiments.

SI Message Specifications

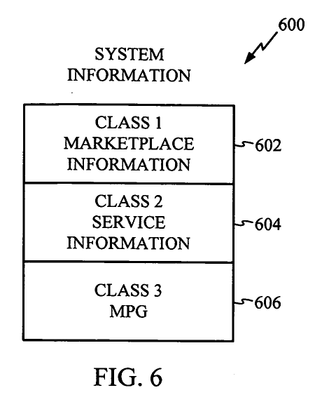

FIG. 6 shows an embodiment of an SI structure 600 for use in embodiments of a distribution system. The SI information is transmitted as a set of SI messages. The following sections specify the definition, semantics and associated processing of SI information contained in the SI messages. In one embodiment, the SI messages are organized into marketplace information 602, service information 604, and a MPG 606 as follows.
Class 1. Marketplace Information that is related to the packaging of service offerings to which a user may subscribe.
Class 2. Service Information that provides information about the attributes of the available services and their location within the distribution network.
Class 3. Media Presentation Guide information that provides information about individual presentations on a service.
   Common Formatting and Processing
   SI Message Syntax

In one or more embodiments, the structures of the SI Messages are defined as a set of XML schema conformant to XML 1.0.

Identification of SI Message Versions

Each transmitted SI message contains a version attribute, which distinguishes copies of different SI messages of the same message type. For certain types of SI messages the version may also distinguish SI messages with the same value of a specified attribute, called the Distinguishing Attribute. For example, the Distinguishing Attributes for two messages are as follows:
Marketplace Content Packager Message: Content Packager ID
MPG Title Block Message: MPG Block Start Time.

The value of the version attribute may be the same for all SI messages representing a single set of element and attribute values. The value of the version attribute may be incremented when any attribute or element of the SI message, other than the Distinguishing Attribute, is modified or created.

In one embodiment, the version attribute is an unsigned integer. The size of the attribute depends on the type of SI message, as specified for the individual message types. Once the version has changed, the value of the version associated with that version of the SI message may not be reused for a time T_UPDATE. The value of T_UPDATE may be in units of seconds, and in one embodiment, is a configurable system parameter.

Identification of Current SI Message Versions

The values of the version field for the current versions of SI messages are sent over the distribution network in a primary Flow.

Update of SI Message Versions

If an SI message contains an update to an attribute or element value, or a new instance of an element, that is scheduled to take effect at a future time, the message may contain a Validity Time value associated with the element being updated, as specified for individual elements. If two versions of an element are being transmitted simultaneously in different Message versions (typically, the current and next versions), each version is associated with a Validity Time. The Validity Time attribute may be a 32-bit count of seconds.

Class 1: Marketplace Information

In one or more embodiments, the SI provides marketplace information in two message types described as follows.
1. Marketplace Common Messages
2. Marketplace Content Packager Messages
   1. Marketplace Common Message

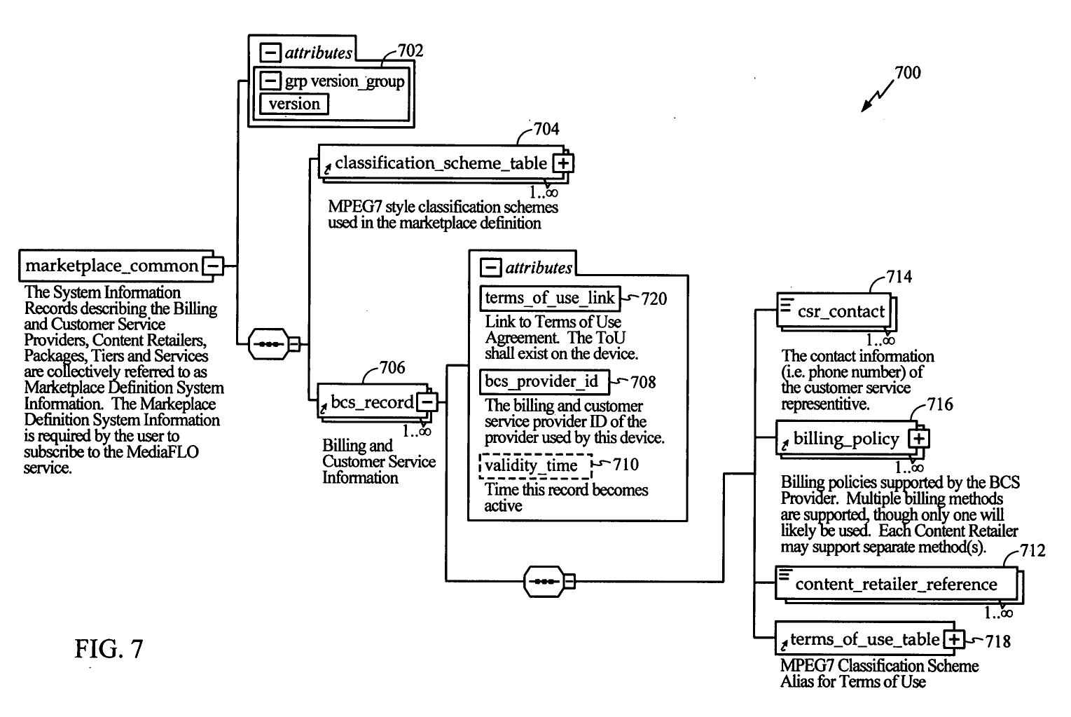

FIG. 7 shows an embodiment of a Marketplace Common message schema 700 for use in embodiments of a distribution system. The Marketplace Common message defines marketplace information that is not specific to any content packager. The Marketplace Common message defines the attributes of the BCS providers configured within the distribution network, references to content packagers associated with each BCS provider, and classification schemes for the controlled terms.

Version

The Marketplace Common message comprises a unique version 702 identified by the value of a version attribute. In one embodiment, the version attribute is a 16-bit unsigned integer.

Classification Scheme Tables

The Marketplace Common message 700 comprises classification scheme tables 704 that define classification schemes used by all BCS providers in the network to specify the following.
Billing Environment
Service Account Type
Currencies
Subscription Method
Genre
MIME type
Rating levels
Device Class

The Classification Scheme Table 704 may comprise any suitable structure. In one embodiment, the definitions of Classification Scheme Table 704 are subject to the requirements and capabilities of the BCS provider and the regulatory requirements that the BCS provider is subject to.

BCS Record

The Marketplace Common message 700 comprises a BCS Record 706 for each BCS provider in the distribution network. In one embodiment, the BCS Record 706 defines a BCS provider and supplies the following items.
BCS Provider ID
Validity Time
CSR Contact
Billing Policy
Content Packager Reference
Terms of Use Table
Terms of Use Link
   BCS Provider ID

The BCS provider ID 708 attribute is a globally unique ID associated with an individual BCS provider. In one embodiment, the BCS provider ID 708 may be an unsigned 16-bit integer.

Validity Time

The Validity Time attribute 710 defines a time at which the definition provided in the BCS Record 706 shall become valid, superseding the previous definition. If the Validity Time is absent or it refers to a time in the past, the BCS Record 706 is current. In one embodiment, the Validity Time attribute 710 may be a 32-bit count of seconds elapsed since 00:00:00 of any selected calendar date.

A BCS record 706 may define one Validity Time. The Validity Time shall be present when multiple records appear for the same BCS provider. In this case, both the current and future record definition contain the Validity Time attribute, with the appropriate value for the record. The validity time may also be present for records defining BCS providers that are not yet active.

Content Packager Reference

The Content Packager Reference 712 is a list of Content Packager IDs identifying Content Packagers associated with the BCS provider. A subscriber associated with the BCS provider may only subscribe to packages offered by Content Packagers included in the Content Packager Reference 712. The Content Packager Reference 712 contains at least one Content Packager ID.

CSR Contact

The CSR Contact 714 element describes possible ways to contact the customer service representatives for the BCS. The BCS Record 706 provides at least one CSR contact 714. Each CSR Contact may be a URI. The following examples show how different classes of URI may be used for a CSR contact 714.
TEL:URI defines a telephone number the subscriber may call for customer assistance.
MAILTO:URI specifies an email address the subscriber may use for customer assistance.
HTTP:URI specifies a web site the subscriber may use for customer assistance.
   Billing Policies

The Billing Policy 716 specifies a billing policy supported by the BCS provider on behalf of Content packagers. Each BCS provider supports at least one Billing Policy 716. In one embodiment, the Billing Policy 716 comprises a Billing Environment and Service Account Type attributes.

a. Billing Environment

The Billing Environment indicates the particular type of device to which a billing policy applies. Examples of Billing Environment which may be supported include “BREW”, “payPal”.

b. Service Account Type

The Service Account Type indicates the identifier used for the service account billing ID. Examples of Service Account Type which may be supported include “MIN”, “MDN”, “BREW SID”, “Credit Card”, and “Prepay”.

Terms of Use Table

The Terms of Use Table 718 is provided that represents a classification scheme used by the BCS provider to define controlled terms for accessing Terms of Use associated with the BCS provider.

Terms of Use Link

The Terms of Use Link 720 is provided that is a reference to an URI that identifies the location of a Terms of Use which the BCS provider requires a user to agree to before providing the user with access to packages offered by the content packager if the content packager does not provide end user license agreement (EULA) information.

2. Marketplace Content Packager Message

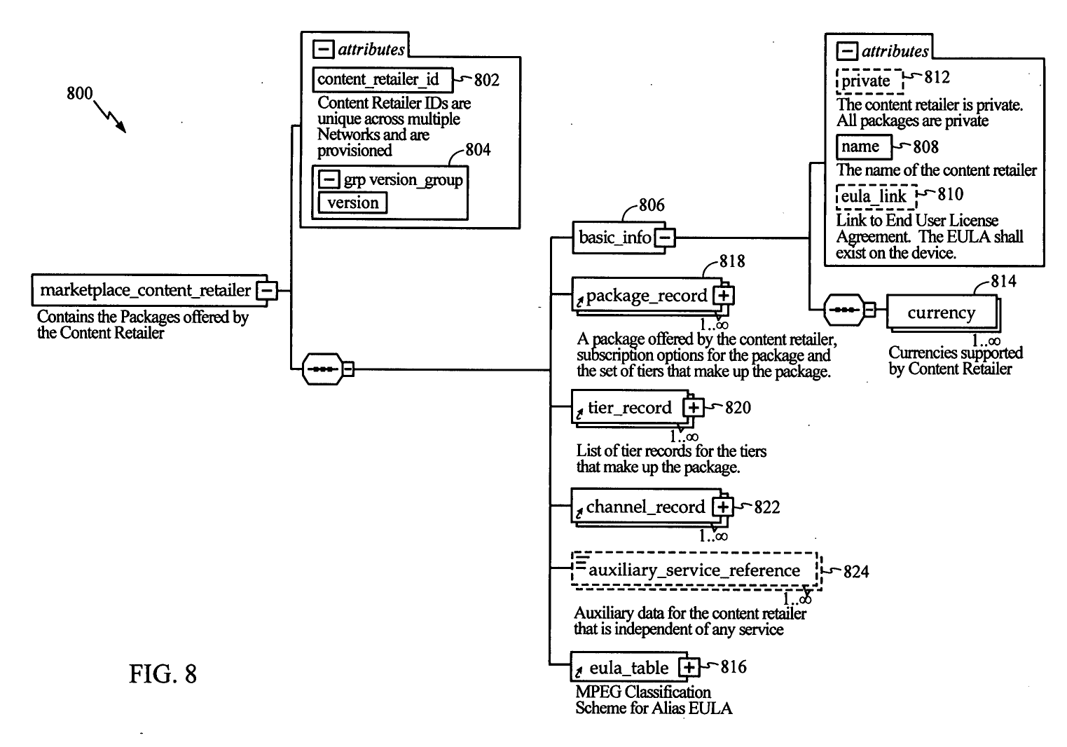

FIG. 8 shows an embodiment of a Marketplace Content Packager message 800 schema for use in embodiments of a distribution system. Information specific to a content packager is sent in the Marketplace Content Packager message 800. Each version of a Marketplace Content Packager message 800 is uniquely identified by the values of its Content Packager ID 802 and version attribute 804. In one embodiment, the version attribute 804 is a 16-bit unsigned integer. The Marketplace Content Packager 800 message contains the following elements.
Content Packager ID
Basic Info
EULA Table
Package records
Tier records
Channel records
Auxiliary service references
   Content Packager ID

Each Content Packager is uniquely distinguished from all other Content Packagers in the distribution network by a Content Packager ID 802. The Content Packager is associated with at least one BCS provider. In one embodiment, the Content Packager ID 802 is an unsigned 16 bit integer.

Basic Info

In one embodiment, a Basic Information 806 record provides the following information.
The Content Packager Name.
A link to the content packager EULA.
Private Content Packager Indicator.
Currency Support
   There shall be one Basic Information 806 record for each content packager.
   Content Packager Name

The Content Packager Name 808 is a string that may be used to identify the content packager to a user. The Content Packager Name 808 is unique among content packagers carried in the distribution network.

EULA Link

The EULA Link 810 is a reference to a URI that identifies the location of a EULA which the content packager may require a user to agree to before providing the user with access to packages offered by the content packager. In one embodiment, the EULA Link 810 is optional. If the content packager does not provide one, the BCS provider Terms of Use Table 718 for the BCS provider associated with the user may be used.

Private Content Packager

The Basic Information record 806 may specify that the content packager is a Private Content Packager 812. The means by which a user subscribes to packages offered by a private content packager 812 are beyond the scope of this document.

Currency Support

The Basic Information record 806 shall specify a Currency 814 element, which defines a list of the currencies that may be used by the content packager to set pricing for packages.

EULA Table

The EULA Table 816 is a classification scheme table used by the content packager to define terms for accessing the EULA associated with the content packager. In one embodiment, the EULA table 816 is optional. If the content packager does not provide one, the BCS provider Terms of Use Table 718 for the BCS provider associated with the user may be used.

Package Records

The Marketplace Content Packager message 800 includes at least one Package Record 818. The Package Record 818 defines a set of content offerings available through the content packager, and certain associated attributes. A more detailed description of the Package Record 818 is provided in another section of this document.

Tier Record

The Marketplace Content Packager message 800 includes a Tier Record 820 for each Tier referenced by any package. The Tier Record 820 defines a tier, which refers to a group of channels. There is a Tier Record 820 for each tier used by the content packager. In one embodiment, the Tier Record 820 specifies the following information.
The Tier ID
The Validity Time of the Record
The set of Channels included in the Tier.
The set of Auxiliary Services added to the Tier
   Tier ID

The Tier ID is an identifier that uniquely distinguishes the tier from all other tiers offered by the same content packager. In one embodiment, the Tier ID is an unsigned 16-bit integer.

Tier Validity Time

The Validity Time attribute defines a time at which the definition provided in the Tier Record 820 shall become valid, superseding the previous definition. If the Validity Time is absent or it refers to a time in the past, the Tier Record 820 is current. In one embodiment, the Validity Time attribute is a 32-bit count of seconds elapsed since 00:00:00 of any selected calendar date.

The Tier Record 820 may define one Validity Time. The Validity Time is present when multiple records appear for the same Tier. In this case, both the current and future record definitions contain the Validity Time attribute, with the appropriate value for the record. The validity time is also present for records defining Tiers that are not yet active.

Channel References

The Tier Record 820 specifies a list of channel references that describe the channels in the tier offering. The channels are defined in the Channel Record associated with the content packager. The Tier Record 820 contains at least one channel reference.

Auxiliary Service References

The Tier Record 820 specifies the list of service identifiers for Auxiliary Services associated with this Tier. A device subscribed to packages that include the Tier shall acquire any material downloaded through Auxiliary Services while it is active.

Channel Record

The Marketplace Content Packager message 800 includes a Channel Record 822 for each channel referenced by any Tier. The Channel Record 822 defines a channel, which is a customization of a service for the content packager. In one embodiment, the Channel Record 822 is comprised of the following elements.
Channel ID
Channel Validity Time
Channel Weight
Channel Language-specific Data
Base Service
Auxiliary Services
Channel Icon
Channel ID

The Channel ID is an identifier that uniquely distinguishes the Channel from other Channels offered by the same Content packager. In one embodiment, the Channel ID is an unsigned 16-bit integer.

Validity Time

The Validity Time attribute defines a time at which the definition provided in the Channel Record 822 shall become valid, superseding the previous definition. If the Validity Time is absent or it refers to a time in the past, the Channel Record is current. In one embodiment, the Validity Time attribute is a 32-bit count of seconds elapsed since 00:00:00 of any selected calendar date.

A Channel Record 822 may define at most one Validity Time. The Validity Time shall be present when multiple records appear for the same Channel. In this case, both the current and future record definition shall contain the Validity Time attribute, with the appropriate value for the record. The validity time shall also be present for records defining Channels that are not yet active.

Channel Weight

Each Channel Record 822 shall assign a Channel Weight to the Channel. In one embodiment, the Channel Weight is an unsigned integer. The Channel Weight is used by the device to determine the order in which channels are presented to the user when displaying the MPG. Channels with the lower weight are presented first. The Channel Weight is unique amongst all Channels offered by all Content Packagers over all Multiplexes associated with the BCS provider. There is one Channel Weight associated with each Channel Record 822.

Channel Language-specific Data

The Channel Language Specific Data element specifies a Name and Description of the channel associated with a specific language, and may define URLs where the user can obtain further information about the channel.

Each Channel record 822 may contain one or more Channel Language-specific Data Elements. If a Channel Language-specific Data Element is present, its content supersedes the Service Language-specific Data Element for the Base Service in the same language. If there is no Channel Language-specific Data Element in a given language, the device may use the Service Language-specific Data Element for the Base Service in that language. Each Channel record 822 shall contain a Channel Language-specific Data Element per Channel Language.

Base Service Record

The Channel Record 822 specifies a Base Service Record. The Base Service Record identifies the Base Service for the Channel, and certain optional characteristics that are Channel-specific:
Base Service Identifier
Excludability.
Channel-specific Capability Requirements
   Base Service Identifier

The Base Service Record specifies a Base Service Identifier. The Base Service identifier is the service identifier for the Service that the channel customizes.

Auxiliary Services

The Channel Record 822 may define a list of Service Identifiers for Auxiliary Services associated with this channel. The device shall acquire any material downloaded through the Auxiliary Services while it is accessing the channel.

Channel Icon

The Channel Record 822 may provide a channel Icon element that can be used to identify the channel in a display of the MPG to the user. If present, the channel Icon is used in place of the Service Icon. The Channel Icon may be a reference to a resource that defines an icon for the channel, or an actual Icon of a defined MIME type.

Auxiliary Service References

The Marketplace Content Packager message 800 may include a list of auxiliary service references 824 for auxiliary services associated with this content packager. The user shall be automatically subscribed to the listed services if the user subscribes to any package associated with the content packager. The device shall acquire any material downloaded through the auxiliary services while it is active.

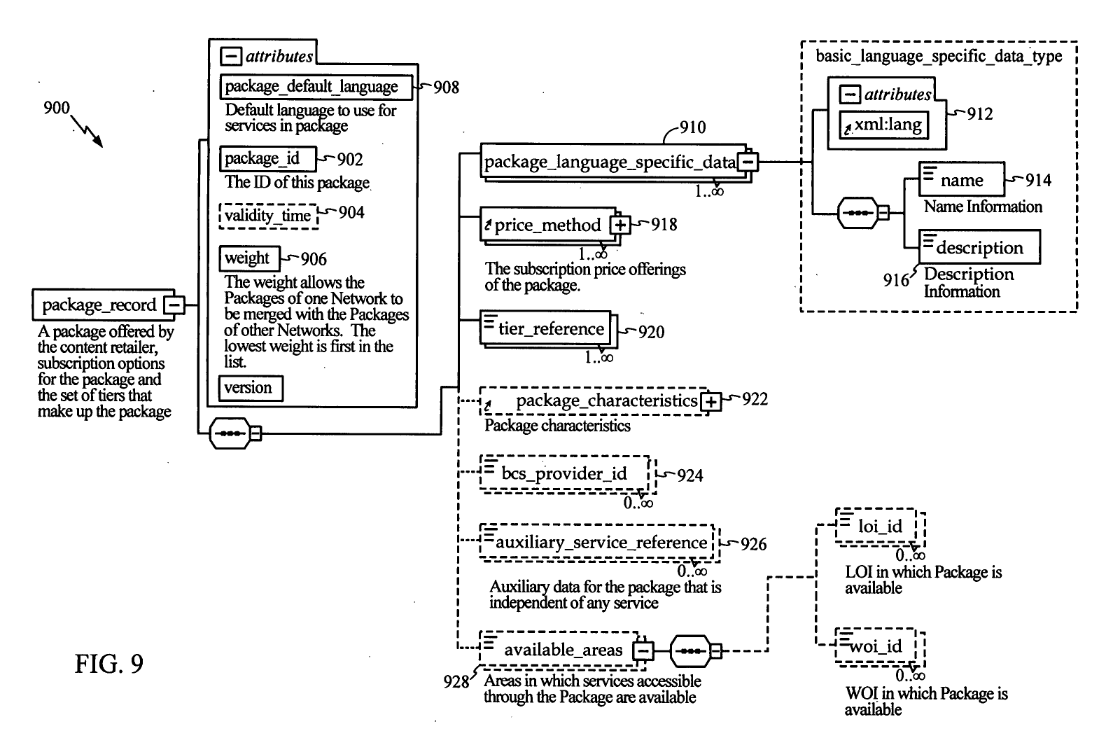

FIG. 9 shows a detailed diagram of an embodiment of a package record schema 900 for use in a Marketplace Content Packager message in embodiments of a distribution system. The package record schema 900 defines a set of content offerings available through the content packager, and certain associated attributes as follows.
Package ID
Package Validity Time
Package Weight
Package Default Language
Language-specific Data
Package Pricing and subscription methods
BCS Provider IDs associated with the Package
Tiers associated with the Package
Package Characteristics
Auxiliary Services associated with the Package
Available Areas
   Package ID

The Package ID 902 is an identifier that distinguishes a particular package from other packages offered by the same content Packager. In one embodiment, the Package ID 902 is an unsigned 16-bit integer. There is one Package ID 902 associated with each package.

Validity Time

The Validity Time attribute 904 defines a time at which the definition provided in the Package Record 900 shall become valid, superseding the previous definition. If the Validity Time 904 is absent or it refers to a time in the past, the Package Record 900 is current. The Validity Time attribute is a 32-bit count of seconds elapsed since 00:00:00 of any selected calendar date.

A Package Record may define at most one Validity Time. The Validity Time shall be present when multiple records appear for the same package. In this case, both the current and future record definition shall contain the Validity Time attribute, with the appropriate value for the record. The validity time shall also be present for records defining packages that are not yet active.

Package Weight

Each Package Record 906 assigns a Package Weight to the package. The Package Weight is an unsigned integer. The Package Weight is used by the device to determine the order in which packages are presented to the user. Packages with the lower weight are presented first.

The Package Weight is unique amongst all packages offered by all content packagers over all multiplexes associated with the BCS provider. There is one Package Weight associated with each Package Record 900.

Package Default Language

The Package Record 900 specifies a Default Language attribute 908. The Default Language attribute 908 specifies the language of the service that will be provided by default to the user if the user's preferred language is not available, unless otherwise overridden. A Package Default Language will be provided if any service which can be accessed through the package supports more than one language.

Package Language-specific Data

The Package Language Specific Data element 910 specifies a name and description of the package associated with a specific language. Each package record contains at least one Package Language-specific Data Element 910. Each package record contains at most one Package Language-specific Data Element per Package Language.

a. Package Language

The Package Language attribute 912 specifies the language of the Package Language Specific Data element 910. Packages that provide descriptions in more than one language specify which language is the default language to use if no language preference is defined on the device.

b. Package Name

The Package Name attribute 914 is a string that specifies a name for the package that may be displayed to the user.

c. Package Description

The Package Description attribute 916 is a string that specifies a description for the Package that may be displayed to the user.

Price Method

The Price Method 918 of a package specifies a cost associated with a given subscription method for the package. It consists of a Subscription Method, a Currency and an Amount. The Package Record 900 specifies at least one Price Method 918. The Package Record 900 specifies at most one Price Method per Subscription Method.

a. Subscription Method

The Subscription Method identifies a subscription method (e.g. monthly, weekly) associated with the cost.

b. Currency

The Currency identifies the currency applicable to the Amount. The Currency is a currency listed in the Basic Info record for the Content Packager. At least one BCS provider associated with the content packager shall support all currencies applicable to a package.

c. Amount

The Amount is the actual price of the package in the case of a Root Package, or the incremental price of the Package additional to the price of the Parent Package in the case of an add-on Package. The Amount attribute is a floating point value conforming to the requirements of the associated Currency.

Tier References

The Package Record 900 shall specify the set of Tier Reference elements 920 that describe the package offering. The Tiers are defined in the Tier Record 820 associated with the Content Packager. The Package Record 900 shall contain at least one Tier Reference 920.

Package Characteristics

The Package Characteristics 922 element is an optional element that specifies certain attributes of the package. The element may specify any combination of the following attributes:
Parent Package.
Autosubscribe Package
Closed Package.
Excluded Packages.
   a. Parent Package

The Package Characteristics 922 element may specify a list of one or more Package IDs representing parent packages. If the package is associated with a Parent Package then the package is an “add-on” package, and the user may only subscribe to the package if the user is already subscribed to at least one package among the parent packages. If no parent packages are listed then the package is defined to be a “Root” package.

b. Autosubscribe Package

If the Package is a Root Package, the Package Characteristics 922 element may specify the Autosubscribe attribute to cause the user to be automatically subscribed to the package.

c. Closed Package

The Package Characteristics 922 element may specify the Closed attribute to indicate that new subscriptions are no longer being accepted for the package.

d. Excluded Packages

The Package Characteristics 922 element may specify a list of one or more Package IDs representing Excluded Packages. A user subscribed to the package specified in the Package Record shall not be permitted to subscribe to any package in the list of Excluded Packages. It is the responsibility of the content packager to define relationships between packages in such a way that the user will not be offered the package if s/he is already subscribed to a package in the Excluded Packages list.

BCS Provider References

The Package Record 900 may specify a list of BCS Provider References 924 associated with the Package. The BCS Provider Reference 924 identifies a BCS provider. Only BCS providers associated with the content packager may be included in the list. If the list is provided then only users associated with an identified BCS provider are permitted to subscribe to the package. If the list is not provided then users associated with any BCS provider that is also associated with the content packager are permitted to subscribe to the package.

Auxiliary Service References

The Package Record 900 may include a list of Auxiliary Service References 926 for Auxiliary Services associated with this Package. The device subscribed to the package shall acquire any material downloaded through the Auxiliary Services while it is active.

Available Areas

The Package Record 900 may include an Available Areas element 928 comprising of a list of local (LOI) and wide area (WOI) operations infrastructure. The list indicates WOIs and LOIs in which at least one service offered as a channel through the package may be accessed. In one embodiment, the LOI and WOI are 16-bit unsigned integers that uniquely identify a geographical region.

Class 2: Service Information

In one or more embodiments, the SI provides service information in a single message referred to as a Service Definition Message.

Service Definition Message

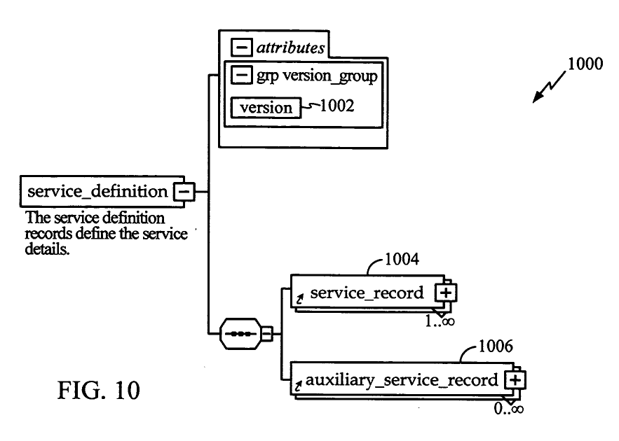

FIG. 10 shows an embodiment of a service definition message 1000 schema for use in embodiments of a distribution system. The service definition message 1000 defines those content attributes of a service which are shared between channels offered by different content packagers that use the service as a base service. It also defines default content attributes that may be used in the event that a content packager does not define customized values for the corresponding attributes in the channel definition record.

The service definition message 1000 defines those content attributes of an auxiliary service which are shared between channels offered by different content packagers that use the auxiliary service. Auxiliary services may be Non Real Time Services. They may be used by the content packager to build up a cache of material such as advertisements, barkers, intros, and outros that can be used to customize the channels defined for the content packager.

Version

The service definition message 1000 comprises a version 1002 that is uniquely identified by the value of its version attribute. In one embodiment, the version attribute is a 16-bit unsigned integer.

Service Record

The Service Definition message 1000 comprises one or more Service Records 1004.

Auxiliary Service Records

The Service Definition message 1000 may comprise one or more Auxiliary Service Records 1006. In one embodiment, there is one Auxiliary Service Record for each auxiliary service offered by the distribution network. The Auxiliary Service Record 1006 comprises the following information.
Auxiliary Service ID
Auxiliary Service Validity Time
Auxiliary Capability Requirements
Auxiliary Flow Records
   Service Record

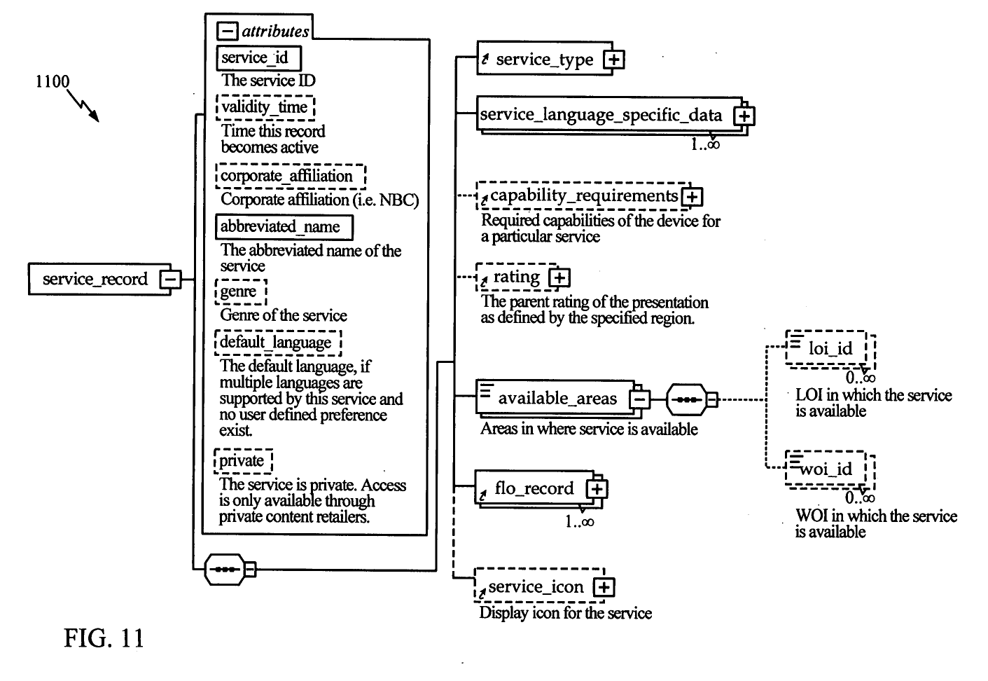

FIG. 11 shows an embodiment of a service record 1100 schema for use in embodiments of a distribution system. For example, the service record 1100 is suitable for use as the service record 1004. In one embodiment the SI from the distribution network provides one service record for each service offered. The Service Record 1100 comprises of the following information.
Service ID
Validity time
Corporate Affiliation
Abbreviated Name
Service Genre
Default Language
Private Service
Service Type
Service Language Specific Data
Capability Requirements
Ratings
Available Areas
Flow Records
Service Icon
   Service ID

The Service Record 1100 provides a Service ID 1102. The Service ID 1102 is an identifier that uniquely distinguishes the service from other services and auxiliary services transported in the same Multiplex.

In one embodiment, the Service ID 1102 is a 16-bit hexadecimal integer. The value of a Service ID 1102 for a service used to transport IP Datacast services may be equal to the destination IP Address.

Validity Time

The Validity Time 1104 defines a time at which the definition provided in the Service Record 1100 shall become valid, superseding the previous definition. If the Validity Time is absent or it refers to a time in the past, the Service Record is current.

In one embodiment, the Validity Time 1104 is a 32-bit count of seconds elapsed since 00:00:00 of any selected calendar date.

The Service Record 1100 may define at most one Validity Time. The Validity Time is present when multiple records appear for the same service. In this case, both the current and future record definition shall contain the Validity Time parameter, with the appropriate value for the record. The validity time is also present for records defining Services that are not yet active.

Corporate Affiliation

The Service Record 1100 provides a Corporate Affiliation 1106. The Corporate Affiliation parameter is a string that defines the corporate name for the service. Multiple services may share the same value of Corporate Affiliation.

Abbreviated Name

The Service Record 1100 provides an Abbreviated Name 1108. The Abbreviated Name parameter 1108 is a string that defines a short name for the service that may be displayed to the user. Each service has an Abbreviated Name that is unique within any Multiplex transporting the Service.

Genre

The Service Record 1100 provides a Genre parameter 1110. The Genre parameter 1110 is a reference that describes the semantic class of content provided by the service.

Default Language

The Service Record 1100 provides a Default Language parameter 1112. The Default Language parameter 1112 specifies the language of the service that shall be provided by default to the user if the user's preferred language is not available, unless overridden by the default language of the Package Record. The Default Language shall be provided if the service supports more than one language.

Private Service

The Service Record 1100 may specify that the service is private using the Private parameter 1114. Access to a private service may be offered through a Private content packager. Information about a private service, including the existence of the service, may not be disclosed to users who are not permitted to access at least one private content packager that offers access to the service.

Service Type

The Service Record 1100 provides a Service Type parameter 1116. The Service Type parameters 1116 indicate the temporal nature of the content provided by the service. There are four possible Service Types: Real Time, Non-real Time, “Per MPG” or IP Datacast.

a. Real Time Service

All content on a Real Time Service consists of Real Time streaming media.

b. Non Real Time Service

All content on a Non Real Time Service consists of non-Real Time media downloaded as clip files.

c. Per MPG Service

Content on a “Per MPG” Service may comprise Real Time streaming media, non-Real Time media, or a mixture of the two, as determined from the Media Presentation Guide (MPG).

d. IP Datacast Service

The content of an IP Datacast Service consists of one or more Flows transporting generic IP packets. Each Flow supporting the IP Datacast Service transports IP packets for a specific IP Multicast Address and Port. Each IP Address is associated with at least one MIME Type.

The Service Type parameter 1116 for an IP Datacast Service provides either all IP Addresses and ports associated with the service or none. If no IP Address is provided, the structure and contents of the IP Datacast Service is determined by any suitable means.

Service Language Specific Data

The Service Record 1100 provides at least one Service Language Specific Data parameter 1118. The Service Language Specific Data parameter 1118 specifies the Name and Description of the service associated with a specific language. There also exists a Service Language Specific Data parameters for the Default Language supported by the service

Capability Requirements

The Service Record 1100 provides Capability Requirements 1120 for the service if the service is not a Real Time Service. If the device does not meet the Capability Requirements 1120 for subscribed users and the channel using the service is not excludable then the user may not be permitted to subscribe to the package containing the channel. In one embodiment, the Capability Requirements 1120 comprise one or more storage requirements that specify the maximum amount of memory required for a device, in units of kilobytes, to support access to the service for a subscribed user.

Rating

The Service Record 1100 provides one or more Ratings 1122 for the service. The Rating defines the parental advisory information for this Service. It typically corresponds to an average or typical Rating level for MPG Titles offered on the Service. The Rating 1122 comprises a Rating Region that specifies the geographical region in which the Rating applies. There may be a separate Rating for each Rating Region in which the service is offered. There shall be at most one Rating for each Rating Region in which the service is offered.

Available Areas

The Service Definition Record 1100 comprises an Available Areas element 1124 that comprises a list of LOI and WOI identifiers. The list indicates WOIs and LOIs in which the service may be accessed. There is at least one LOI or WOI ID in the Available Areas element 1124. In one embodiment, the LOI and WOI identifiers are 16-bit unsigned integers that uniquely identify a geographical region.

Flow Record

The Service Record 1100 provides one Flow Record 1126 for each Flow used to transport a component of the service. The Flow Record 1126 is comprised of the following information.
Flow ID
Flow Routing Type
Flow MIME Type
Flow Language
Flow Configuration Flags
IP Datacast Specification.
   Service Icon

The Service Record 1100 provides a Service Icon parameter 1128 that can be used to identify the service in a display of the MPG to the user. The Service Icon parameter 1128 may be a reference to a resource that defines an icon for the service, or an actual Icon of a defined MIME type.

Class 3: Media Presentation Guide information

The Media Presentation Guide (MPG) provides information about the contents of the channels which may be displayed to the user or downloaded to the device. The contents of a given channel are divided by time into semantically coherent units which share a common MPG Title. The MPG Title is associated with the Base Service for the channel.

In one embodiment, the MPG provides MPG Title Records for all services available in a particular multiplex. The MPG may provide MPG Title Records for services available in various Multiplexes in the network.

Therefore various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

Accordingly, while embodiments of a distribution system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for distributing content, the method comprising:
receiving billing and customer service (BCS) parameters that identify one or more content packagers that are associated with one or more BCS providers;
receiving packager parameters that describe one or more packages associated with the one or more content packagers;
generating system information that comprises the BCS parameters and the packager parameters; and
transmitting the system information.

2. The method of claim 1, further comprising;
receiving one or more programming parameters, wherein the programming parameters are associated with the one or more packages; and
generating the system information to comprise selected programming parameters.

3. The method of claim 1, further comprising receiving the BCS parameters from the one or more BCS providers.

4. The method of claim 1, further comprising receiving the packager parameters from the one or more content packagers.

5. The method of claim 1, further comprising generating the system information to comprise a media presentation guide.

6. The method of claim 1, further comprising transmitting the system information over a distribution network.

7. The method of claim 1, further comprising transmitting the system information in a wireless transmission.

8. Apparatus for distributing content, the apparatus comprising:
receiver logic configured to receive BCS parameters that identify one or more content packagers that are associated with one or more BCS providers, and packager parameters that describe one or more packages associated with the one or more content packagers;
system information logic configured to generate system information that comprises the BCS parameters and the packager parameters; and
transmitter logic configured to transmit the system information.

9. The apparatus of claim 8, further comprising;
logic configured to receive one or more programming parameters, wherein the programming parameters are associated with the one or more packages; and
logic configured to generate the system information to comprise selected programming parameters.

10. The apparatus of claim 8, further comprising logic configured to receive the BCS parameters from the one or more BCS providers.

11. The apparatus of claim 8, further comprising logic configured to receive the packager parameters from the one or more content packagers.

12. The apparatus of claim 8, further comprising logic configured to generate the system information to comprise a media presentation guide.

13. The apparatus of claim 8, further comprising logic configured to transmit the system information over a distribution network.

14. The apparatus of claim 8, further comprising logic configured to transmit the system information in a wireless transmission.

15. Apparatus for distributing content, the apparatus comprising:
means for receiving BCS parameters that identify one or more content packagers that are associated with one or more BCS providers;
means for receiving packager parameters that describe one or more packages associated with the one or more content packagers;
means for generating system information that comprises the BCS parameters and the packager parameters; and
means for transmitting the system information.

16. The apparatus of claim 15, further comprising;
means for receiving one or more programming parameters, wherein the programming parameters are associated with the one or more packages; and
means for generating the system information to comprise selected programming parameters.

17. The apparatus of claim 15, further comprising means for receiving the BCS parameters from the one or more BCS providers.

18. The apparatus of claim 15, further comprising means for receiving the packager parameters from the one or more content packagers.

19. The apparatus of claim 15, further comprising means for generating the system information to comprise a media presentation guide.

20. The apparatus of claim 15, further comprising means for transmitting the system information over a distribution network.

21. The apparatus of claim 15, further comprising means for transmitting the system information in a wireless transmission.

22. A computer-readable media comprising instructions, which when executed by at least one processor, operate to distribute content, the computer-readable media comprising:
instructions for receiving BCS parameters that identify one or more content packagers that are associated with one or more BCS providers;
instructions for receiving packager parameters that describe one or more packages associated with the one or more content packagers;
instructions for generating system information that comprises the BCS parameters and the packager parameters; and
instructions for transmitting the system information.

23. The computer-readable media of claim 22, further comprising;
instructions for receiving one or more programming parameters, wherein the programming parameters are associated with the one or more packages; and
instructions for generating the system information to comprise selected programming parameters.

24. The computer-readable media of claim 22, further comprising instructions for receiving the BCS parameters from the one or more BCS providers.

25. The computer-readable media of claim 22, further comprising instructions for receiving the packager parameters from the one or more content packagers.

26. The computer-readable media of claim 22, further comprising instructions for generating the system information to comprise a media presentation guide.

27. The computer-readable media of claim 22, further comprising instructions for transmitting the system information over a distribution network.

28. The computer-readable media of claim 22, further comprising instructions for transmitting the system information in a wireless transmission.

29. At least one processor configured to perform a method for distributing content, the method comprising:
receiving BCS parameters that identify one or more content packagers that are associated with one or more BCS providers;
receiving packager parameters that describe one or more packages associated with the one or more content packagers;
generating system information that comprises the BCS parameters and the packager parameters; and
transmitting the system information.

30. The method of claim 29, further comprising;
receiving one or more programming parameters, wherein the programming parameters are associated with the one or more packages; and
generating the system information to comprise selected programming parameters.

31. The method of claim 29, further comprising receiving the BCS parameters from the one or more BCS providers.

32. The method of claim 29, further comprising receiving the packager parameters from the one or more content packagers.

33. The method of claim 29, further comprising generating the system information to comprise a media presentation guide.

34. The method of claim 29, further comprising transmitting the system information over a distribution network.

35. The method of claim 29, further comprising transmitting the system information in a wireless transmission.

36. A method for providing system information, the method comprising:
receiving system information messages;
determining a BCS provider identifier;
parsing the system information messages based on the BCS provider identifier to determine parsed system information parameters; and
rendering a selected portion of the parsed system information parameters.

37. The method of claim 36, wherein said receiving comprises receiving the system information messages in a wireless transmission.

38. The method of claim 36, wherein said receiving comprises receiving the system information messages that identifies one or more content packagers that are associated with one or more BCS providers.

39. The method of claim 36, wherein said parsing comprises comparing the BCS provider identifier to one or more BCS identifiers contained in the system information messages to determine the parsed system information parameters.

40. Apparatus for providing system information, the apparatus comprising:
receiving logic configured to receive system information messages;
parsing logic configured to determine a BCS provider identifier, and parse the system information messages based on the BCS provider identifier to determine parsed system information parameters; and
rendering logic configured to render a selected portion of the parsed system information parameters.

41. The apparatus of claim 40, wherein said receiving logic is configured to receive the system information messages in a wireless transmission.

42. The apparatus of claim 40, wherein said system information messages identify one or more content packagers that are associated with one or more BCS providers.

43. The apparatus of claim 40, wherein said parsing logic is configured to compare the BCS provider identifier to one or more BCS identifiers contained in the system information messages to determine the parsed system information parameters.

44. A computer-readable media comprising instructions, which when executed by at least one processor, operate to provide system information, the computer-readable media comprising:
instructions for receiving system information messages;
instructions for determining a BCS provider identifier;
instructions for parsing the system information messages based on the BCS provider identifier to determine parsed system information parameters; and
instructions for rendering a selected portion of the parsed system information parameters.

45. The computer-readable media of claim 36, wherein said instructions for receiving comprise instructions for receiving the system information messages in a wireless transmission.

46. The computer-readable media of claim 36, wherein said instructions for receiving comprise instructions for receiving the system information messages that identifies one or more content packagers that are associated with one or more BCS providers.

47. The computer-readable media of claim 36, wherein said instructions for parsing comprise instructions for comparing the BCS provider identifier to one or more BCS identifiers contained in the system information messages to determine the parsed system information parameters.

48. Apparatus for distributing a system information message, the system information message comprising:
a first set of parameters that identifies one or more BCS providers; and
a second set of parameters associated with the first set of parameters, wherein the second set of parameters identifies one or more content packagers.

49. A system information message for providing system information over a distribution network, comprising:
a first set of parameters that identifies one or more BCS providers; and
a second set of parameters associated with the first set of parameters, wherein the second set of parameters identifies one or more content packagers.
